(19) United States
(12) Patent Application Publication
(10) Pub. No.: US 2016/0344090 A1
(43) Pub. Date: Nov. 24, 2016

(54) HOUSING, ELECTRONIC DEVICE EMPLOYING SAME AND MANUFACTURE METHOD

(71) Applicants: SHENZHEN FUTAIHONG PRECISION INDUSTRY CO., LTD., Shenzhen (CN); FIH (HONG KONG) LIMITED, Kowloon (HK)

(72) Inventors: CHWAN-HWA CHIANG, New Taipei (TW); CHIEH-HSIANG WANG, New Taipei (TW); BAO-SHEN ZHANG, Shenzhen (CN); CHEN-YI TAI, New Taipei (TW)

(21) Appl. No.: 14/920,581

(22) Filed: Oct. 22, 2015

(30) Foreign Application Priority Data
May 22, 2015 (CN) 201510265280.3

(51) Int. Cl. H01Q 1/24; H01Q 9/04

(52) U.S. Cl. CPC H01Q 1/243; H01Q 9/0421

(57) ABSTRACT

A housing used in an electronic device having an antenna, the housing includes a base and a non-conductive film. The base defines a slot corresponding to the antenna and forms a surface enclosing the slot. The non-conductive film is formed on a surface of the base, the non-conductive film is configured to be coupled to the antenna and insulated the antenna from the base. An electronic device employing the housing and a manufacture method of the housing are also provided.

### FIELD

The subject matter herein generally relates to a housing, an electronic device employing the housing, and a manufacture method of the housing.

### BACKGROUND

Metal housings of electronic devices are more and more important nowadays. The metal housing may affect antennas in the electronic device. It is general to use plastic injection to connect the antenna and the metal housing when manufacturing process for improving a performance of the antenna. However, some other material may filter into a conjunction portion of the plastic and the metal, which affects a conjunction of the plastic and the metal. In addition, a color and a brightness of the plastic and the metal may have a great difference using the traditional manufacturing process.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is an isometric view of a first embodiment of an electronic device.

FIG. 2 is an exploded isometric view of the electronic device of FIG. 1.

FIG. 3 is a cross-sectional view of the electronic device of FIG. 1 along line III-III.

FIG. 4 is an enlarged, cross-sectional view of encircled portion IV of the electronic device of FIG. 3.

FIG. 5A-5E are perspective views of a first embodiment of a housing manufacturing method.

FIG. 6 is an isometric view of a second embodiment of an electronic device.

FIG. 7 is an exploded isometric view of the electronic device of FIG. 6.

FIG. 8A-8D are perspective views of a second embodiment of a housing manufacturing method.

FIG. 9 is an isometric view of a third embodiment of an electronic device.

FIG. 10 is an exploded isometric view of the electronic device of FIG. 9.

FIG. 11 is an enlarged view of encircled portion XI of the electronic device of FIG. 10.

FIG. 12 is an enlarged view of encircled portion XII of the electronic device of FIG. 10.

FIG. 13A-13E are perspective views of a third embodiment of a housing manufacturing method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

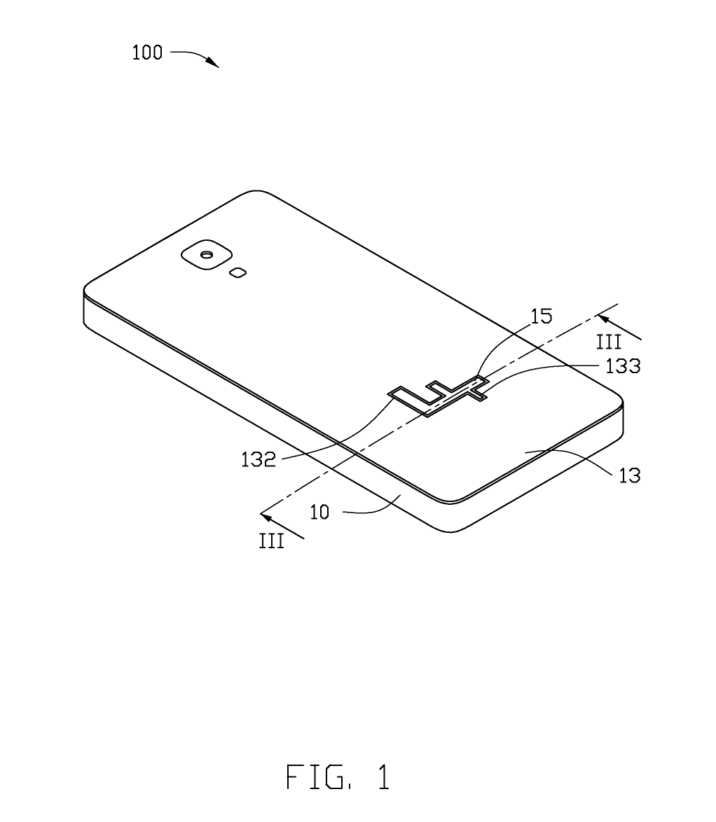

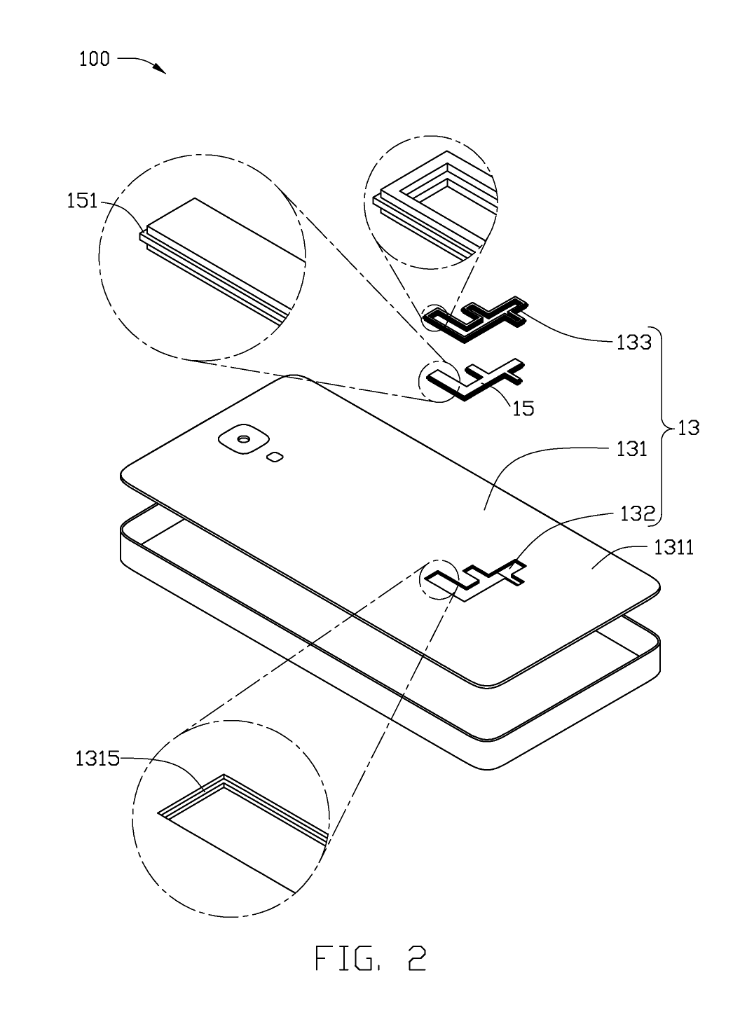

FIG. 1 illustrates an isometric view a first embodiment of an electronic device 100 and FIG. 2 illustrates an exploded isometric view of the electronic device 100. The electronic device 100 can be a mobile phone, a personal digital assistant, and a tablet computer. The electronic device 100 includes a main body 10, a housing 13 formed on the main body 10, and an antenna 15 mounted in the housing 13.

The housing 13 is a thin sheet. In at least one embodiment, the housing 13 is a back cover of the electronic device.

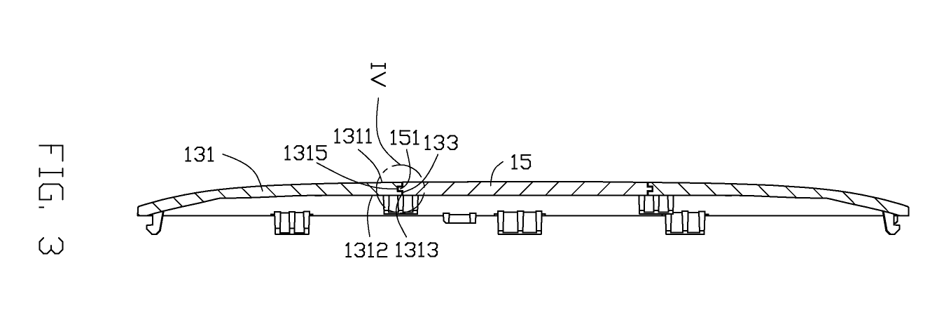

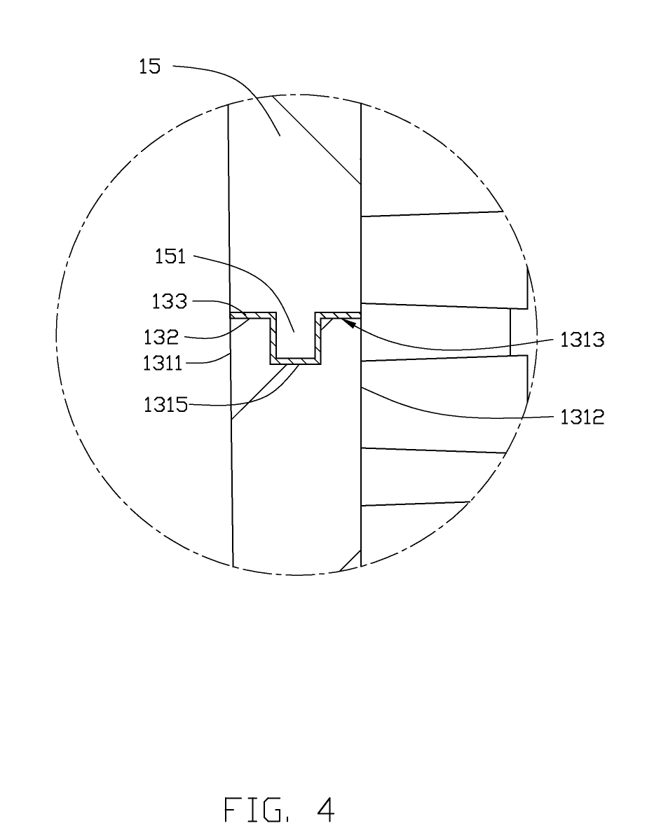

FIGS. 1-4 illustrate the housing 13 including a base 131. The base 131 includes a first surface 1311 and a second surface 1312 opposite to the first surface 1311. The first surface 1311 is an external surface of the housing 13. The base 131 defines a slot 132 in a shape similar to the antenna 15 throughout the first surface 131 and the second surface 132. The base 131 forms a side surface 1313 enclosing the slot 132 and adjacent to the first surface 1311 and the second surface 1312. The side surface 1313 encloses the slot 132. The side surface 1313 defines at least one groove 1315. In at least one embodiment, the side surface 1313 defines one groove 1315 having a same extending direction with the side surface 1313, the groove 1315 is a ring shape.

The base 131 is made of conductive material, such as metal, metal glass, a mix material of metal and ceramic, and carbon fiber plate, the metal material can be such as aluminium, aluminium alloy, titanium, titanium alloy, magnesium, magnesium alloy, zinc, zinc alloy, zirconium, columbium, and stainless steel.

The side surface 1313 having the slot 132 and the surface having the groove 1315 cooperatively form a non-conductive film 133 by surface treatment. A thickness of the non-conductive film 133 can be about 5 micron to 1 millimeter. Preferably, the thickness of the non-conductive film 133 is about 10 to 500 micron. The antenna 15 is received in the slot 132. The non-conductive film 133 covers and combines with the antenna 15. That is, the non-conductive film 133 internally connects the antenna 15 and externally connects the base 131.

The non-conductive film 133 is made of non-conductive material, such as aluminum oxide, titanium, magnesium oxide, zinc oxide, zirconium oxide, columbium oxide, and iron oxide.

When the base 131 is made of metal material, the material of the non-conductive film 133 is selected as the corresponding metal oxide. Thus, the non-conductive film 133 and the base 131 have similar appearances and colors.

The non-conductive film 133 covers the antenna 15 to insulate the antenna 15 from the base 131. Thus, the base 131 made of metal material may not affect the antenna 15 transmitting and receiving signals. In addition, the antenna signals may be transmitted though the non-conductive film 133, which to improve radiation efficiency for the electronic device.

The surface of the antenna 15 connecting the non-conductive film 133 includes at least one inlay 151 corresponding to the groove 1315, the non-conductive film 133 is sandwiched between the antenna 15 and the surface having the groove 1315. Thus, the antenna 15 is firmly coupled to and insulated from the base 131. In at least one embodiment, the inlay 151 is a ring shape and is inserted into the groove 1315.

In other embodiments, the shape of the antenna 15 can be adjusted and a shape of the slot 132 can be adjusted accordingly. In other embodiments, the groove 1315 on the base 131 and the inlay 151 of the antenna 15 can be ignored.

A manufacture method of the housing 13 of the electronic device 100 is described as follows:

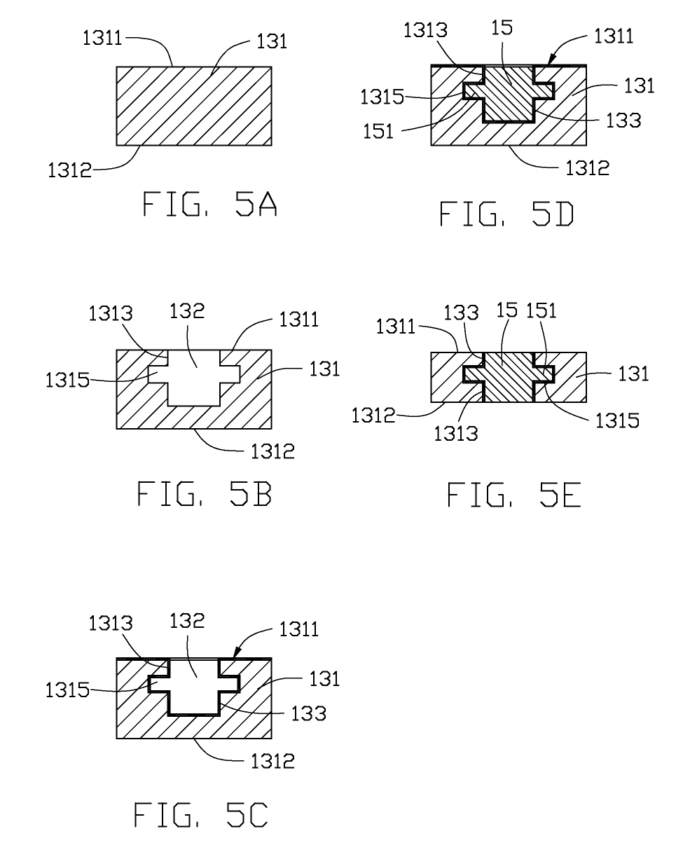

Referring to FIG. 5A, providing a base 131 having a predetermined shape, including the first surface 1311 and the second surface 1312.

The base 131 is made of conductive material.

Referring to FIG. 5B, cutting the base 131 to form a slot 132. Specifically, operating a computer numerical control (CNC) milling treatment to the base 131 to form the slot 132 on the first surface 1311, the slot 132 is recessed from the first surface 1311. Thus, the base 131 forms a side surface 1313 enclosing the slot 132. The side surface 1313 defines at least one groove 1315. In at least one embodiment, the side surface 1313 defines one groove 1315 recessed from the side surface 1313, and the groove 1315 is a ring shape.

Referring to FIG. 5C, processing surface treatment to the base 131 to cooperatively form a non-conductive film 133 by the side surface 1313 forming the slot 132 and the surface forming the groove 1315. The surface treatment can be chemical treatment, anodic oxidation treatment, microarc oxidation treatment, vacuum coating treatment, or spraying treatment. The non-conductive film 133 is made of non-conductive material, thus to connect and insulate the base 131 on sides of the non-conductive film 133. The non-conductive material can be such as aluminum oxide, titanium, magnesium oxide, zinc oxide, zirconium oxide, columbium oxide, and iron oxide. A thickness of the non-conductive film 133 can be about 5 micron to 1 millimeter. Preferably, the thickness of the non-conductive film 133 is about 10 to 500 micron.

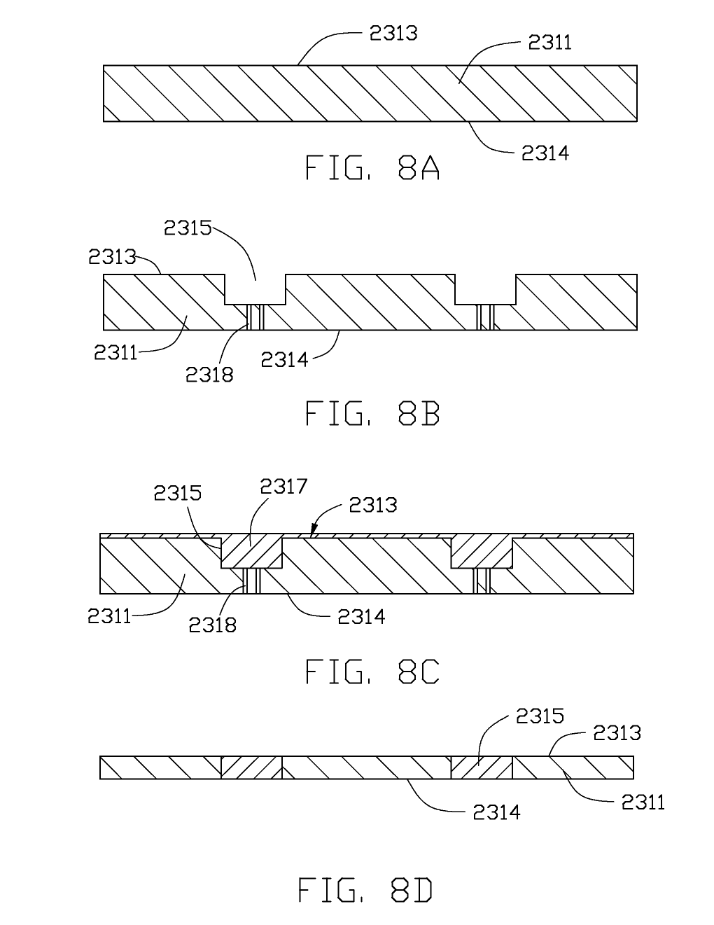

Referring to FIG. 8D, forming the antenna 15 in the slot 132. Specifically, the non-conductive film 133 sandwiches between the antenna 15 and the side surface 1313 of the base 131, and also couples to the antenna 15 to insulate the antenna 15 from the base 131. The antenna 15 can be made by printing or filling metal magma, such as copper or silver. A part of the material is inserted into the groove 1315 to form the inlay 151 when forming the antenna 15. The material may overflow from the slot 132 when forming the antenna 15.

Referring to FIG. 5E, thinning the base 131 to form the housing 13. Specifically, thinning the first surface 1311 and the second surface 1312 by metal cutting or polishing to make the slot 132 throughout the first surface 1311 and the second surface 1312. And then removing excrescent antenna material that overflow from the slot 132 to insulate the antenna 15 from the base 131. In other embodiments, further processing surface treatment to the housing 13, such as anodic oxidation treatment or polishing, to improve a better appearance effect of the first surface 1311.

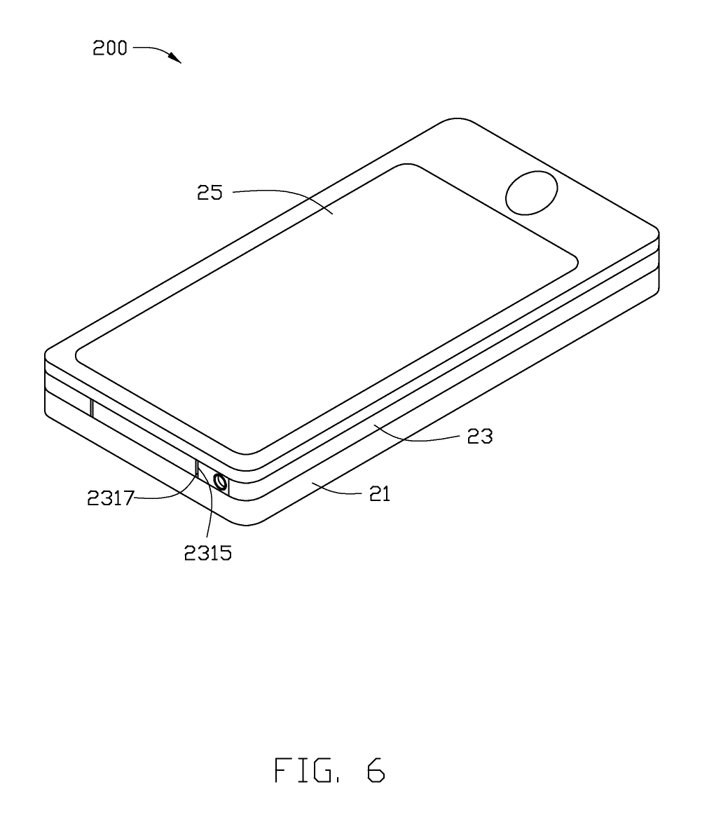

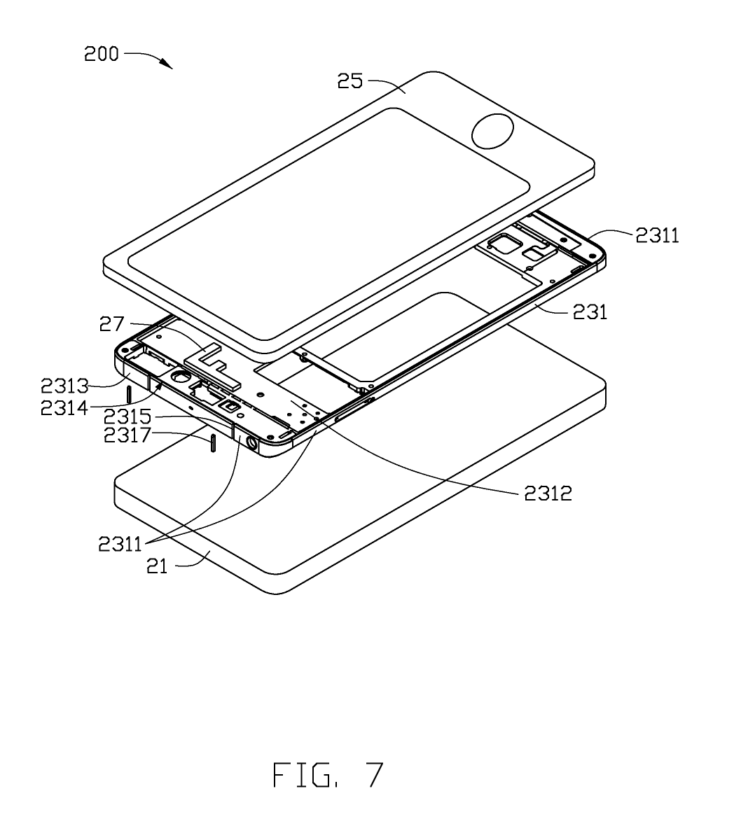

FIGS. 6 and 7 illustrate a second embodiment of the electronic device 200 including a main body 21, a housing 23 formed on the main body 21, a display 25 coupled to the housing 23, and an antenna 27 mounting in the main body 21.

The housing 23 includes a frame 231, the frame 231 includes two opposite arms 2311 and a middle board 2312 connecting the two arms 2311. Each arm 2311 includes a first surface 2313 and a second surface 2314 opposite to the first surface 2313. The first surface 2313 is an external surface and the second surface 2314 is an internal surface of the arms 2311.

The frame 231 is made of conductive material, such as metal, metal glass, a mix material of metal and ceramic, and carbon fiber plate, the metal material can be such as aluminium, aluminium alloy, titanium, titanium alloy, magnesium, magnesium alloy, zinc, zinc alloy, zirconium, columbium, and stainless steel. The arm 2311 forms a plurality of slots 2315 by cutting throughout the first surface 2313 and the second surface 2314. Each slot 2315 separates the arms 2311 into two sections. A width of each slot 2315 can be 100 micron to 5 millimeter. The slots 2315 are corresponding to the antenna 27. In at least one embodiment, the arms 2311 include four slots 2315 and every two slots 2315 are formed on one arm 2311.

A non-conductive film 2317 is formed on a surface of the slots 2315 by surface treatment. The non-conductive film 2317 is filled in the slots 2315 to connect and insulate opposite ends of the arm 2311. A width of the non-conductive film 2317 can be 50 micron to 5 millimeter.

In other embodiments, the non-conductive film 2317 can be formed on the middle board 2312 to improve a conjunction of the non-conductive film 2317 and the arms 2311.

The non-conductive film 2317 is made of non-conductive material, such as aluminum oxide, titanium, magnesium oxide, zinc oxide, zirconium oxide, columbium oxide, and iron oxide, to connect and insulate opposite sides of the frame 231.

When the frame 231 is made of metal material, the material of the non-conductive film 2317 is selected as the corresponding metal oxide. Thus, the non-conductive film 2317 and the frame 231 have similar appearances and colors.

The slot 2315 and the non-conductive film 2317 are corresponding to the antenna 27, thus antenna signals may be transmitted though the non-conductive film 2317, which to improve radiation efficiency for the electronic device 200.

A manufacture method of the housing 23 of the electronic device 200 of second embodiment is described as follows:

Referring to FIG. 8A, providing a frame 231 having a predetermined shape, including two opposite arms 2311 and a middle board 2312 connecting the two arms 2311. Each arm 2311 includes a first surface 2313 and a second surface 2314 opposite to the first surface 2313.

Referring to FIG. 8B, cutting the frame 231 to form a plurality of slots 2315. Specifically, operating a computer numerical control (CNC) milling treatment to the frame 231 to form the slots 2315. The frame 231 further defines at least one gap 2318 from a bottom towards the second surface 2314. The slots 2315 do not reach the second surface 2314. In at least one embodiment, four slots 2315 are formed on the arms 2311. On opposite ends of each arm 2311 define one slot 2315. Each slot 2315 is corresponding to one gap 2318. A width of each slot 2315 can be 100 micron to 5 millimeter. The slots 2315 are corresponding to the antenna 27.

Referring to FIG. 8C, processing surface treatment to the frame 231 to cooperatively form a non-conductive film 2317 by the surface of the arm 2311 forming the slots 2315. The non-conductive film 2317 is received in the slots 2315. The gaps 2318 are configured to exhaust air when forming the non-conductive film 2317 to improve a conjunction of the non-conductive film 2317 in the slots 2315. A width of the non-conductive film 2317 in the slot 2315 is 50 micron to 5 millimeter.

In other embodiments, the non-conductive film 2317 can be formed on the middle board 2312 to improve a conjunction of the non-conductive film 2317 and the arms 2311.

In some cases, some material may overflow from the slots 2315 when forming the non-conductive film 2317 and be formed on the first surface 2313.

The surface treatment can be chemical treatment, anodic oxidation treatment, microarc oxidation treatment, vacuum coating treatment, or spraying treatment. The non-conductive film 2317 is made of non-conductive material, can be such as aluminum oxide, titanium, magnesium oxide, zinc oxide, zirconium oxide, columbium oxide, and iron oxide.

Referring to FIG. 5D, thinning the frame 231 to form the housing 23. Specifically, thinning the first surface 2313 and the second surface 2314 by metal cutting or polishing to make the slots 2315 throughout the first surface 2313 and the second surface 2314. In other embodiments, further processing surface treatment to the housing 23, such as anodic oxidation treatment or polishing, to improve a better appearance effect of the first surface 2313.

The slot 2315 and the non-conductive film 2317 are corresponding to the antenna 27, thus antenna signals may be transmitted though the non-conductive film 2317, which to improve radiation efficiency for the electronic device 200.

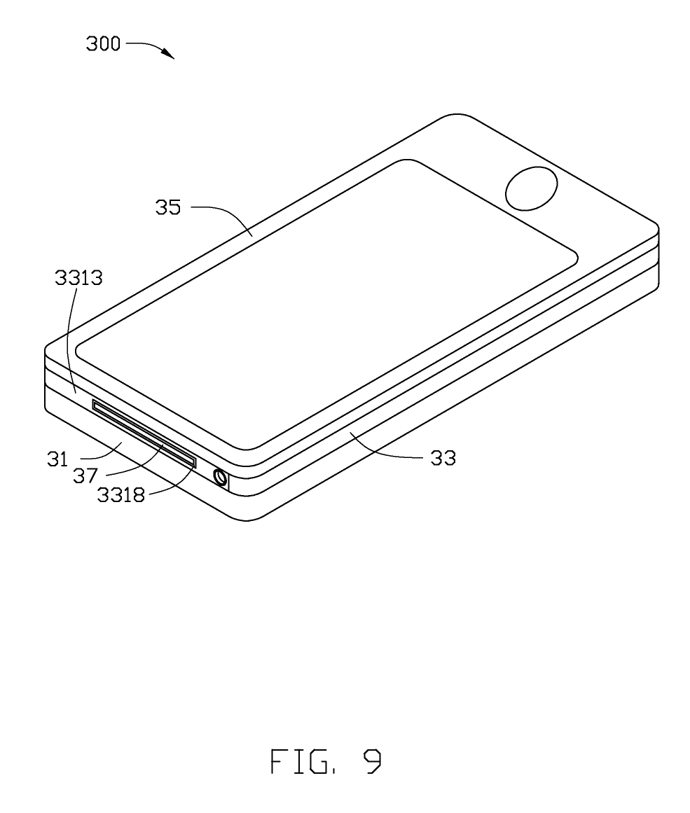

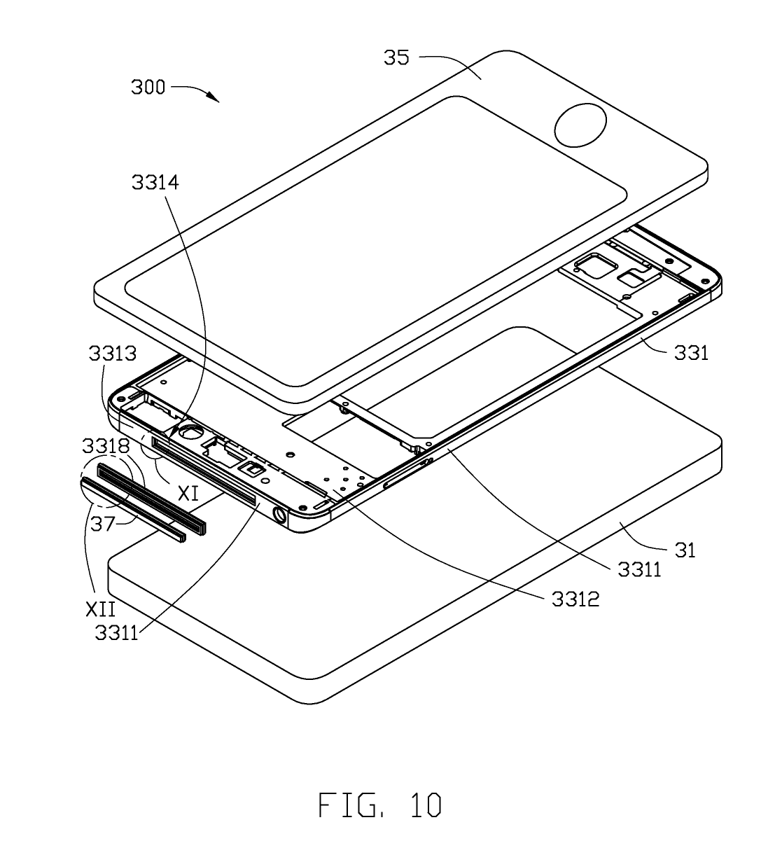

FIGS. 9 and 10 illustrate a third embodiment of the electronic device 300 including a main body 31, a housing 33 formed on the main body 31, a display 35 coupled to the housing 33, and an antenna 37 mounting in the housing 33.

The housing 33 includes a frame 331, the frame 331 includes two opposite arms 3311 and a middle board 3312 connecting the two arms 3311. The arms 3311 include a first surface 3313 and a second surface 3314 opposite to the first surface 3313. The first surface 3313 is an external surface and the second surface 3314 is an internal surface of the arms 3311.

The frame 331 is made of conductive material, such as metal, metal glass, a mix material of metal and ceramic, and carbon fiber plate, the metal material can be such as aluminium, aluminium alloy, titanium, titanium alloy, magnesium, magnesium alloy, zinc, zinc alloy, zirconium, columbium, and stainless steel.

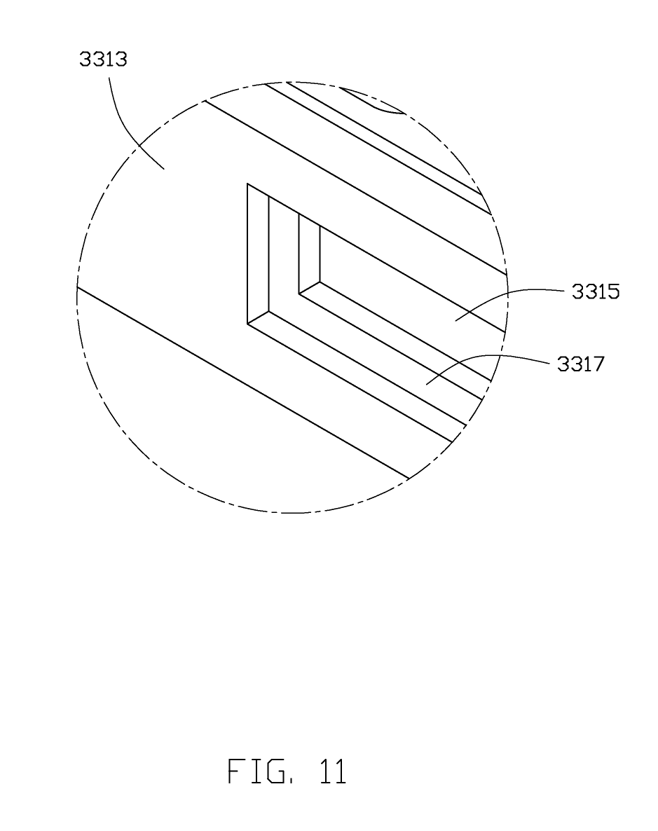

Cooperatively referring to FIG. 11, one of the arm 3311 forms a slot 3315 and a side surface 3316 by cutting treatment. The side surface 3316 defines a notch 3317. In at least one embodiment, the slot 3315 is substantially a rectangular ring shape and the notch 3317 is substantially a ring shape. Part of the arm 3311 or the whole arm 3311 may form the slot 3315.

A non-conductive film 3318 is formed on the side surface 3316 by surface treatment. The non-conductive film 3318 is filled in the slot 3315. A thickness of the non-conductive film 3318 can be 50 micron to 1 millimeter. Preferably, the thickness of the non-conductive film 3318 is 10 micron to 500 micron. The non-conductive film 3318 is made of non-conductive material, such as aluminum oxide, titanium, magnesium oxide, zinc oxide, zirconium oxide, columbium oxide, and iron oxide.

When the frame 331 is made of metal material, the material of the non-conductive film 3318 is selected as the corresponding metal oxide. Thus, the non-conductive film 3318 and the frame 331 have similar appearances and colors.

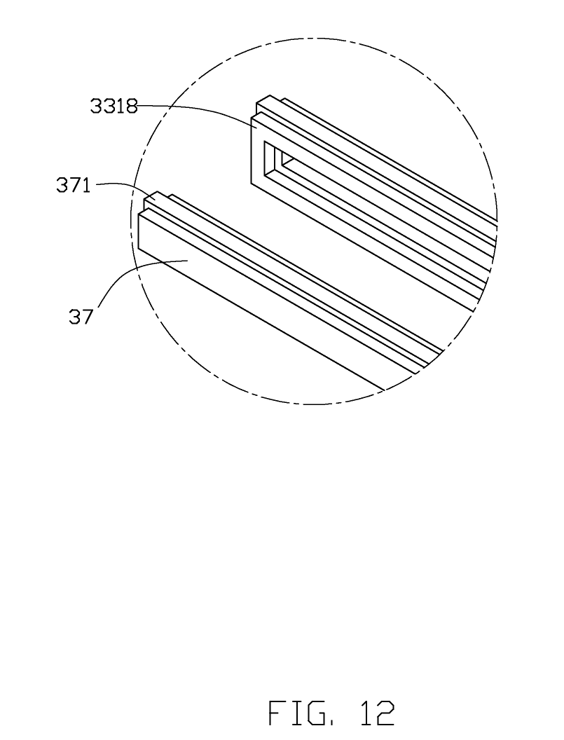

Cooperatively referring to FIG. 12, the antenna 37 is formed in the slot 3315 and is connected to the non-conductive film 3318, thus the antenna 37 is insulated to the frame 331. The surface of the antenna 37 connecting the non-conductive film 3318 includes at least one inlay 371 corresponding to the notch 3317, the non-conductive film 3318 is sandwiched between the antenna 37 and the surface enclosing the notch 3317. Thus, the antenna 37 is firmly coupled to and insulated from the frame 331 by the non-conductive film 3318. In at least one embodiment, the inlay 371 is a ring shape and is inserted into the notch 3317.

In other embodiments, the shape of the antenna 37 can be adjusted and a shape of the groove 3315 can be adjusted accordingly.

A manufacture method of the housing 33 of the electronic device 300 is described as follows:

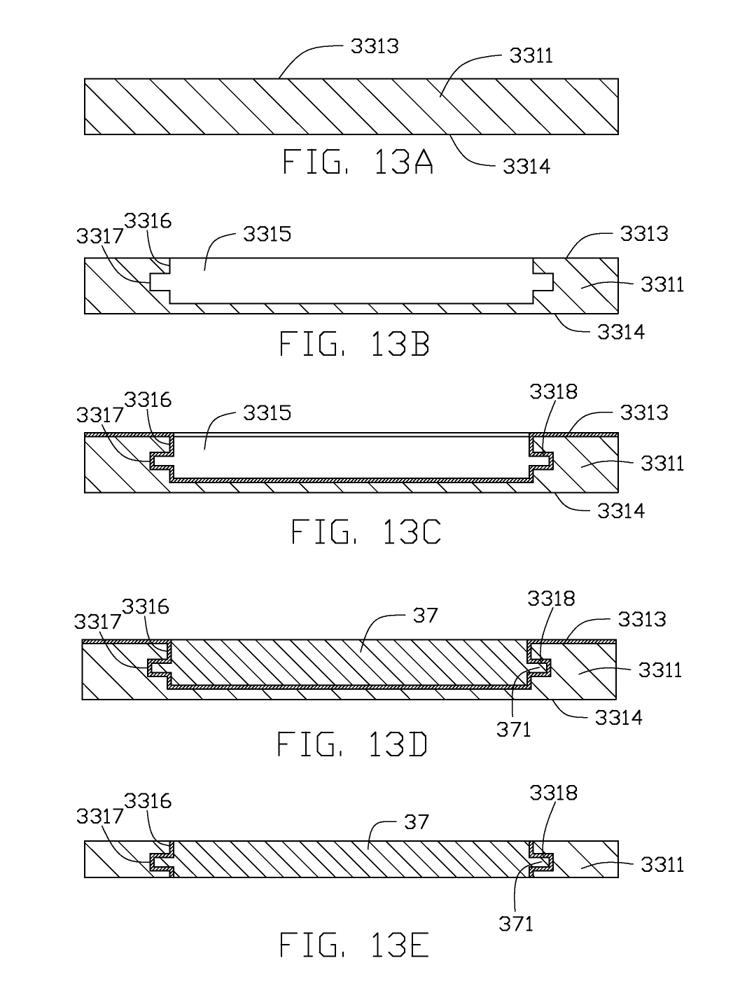

Referring to FIG. 13(a), providing a frame 331 having a predetermined shape, including two opposite arms 3311 and a middle board 3312 connecting the two arms 3311. The arms 3311 include a first surface 3313 and a second surface 3314 opposite to the first surface 3313.

Referring to FIG. 13(b), cutting the frame 331 to form a slot 3315 on one of the arms 3311. Concretely, operating a computer numerical control (CNC) milling treatment to the first surface 3313 or the second surface 3314 of the arm 3311 to form the slot 3315. The frame 231 includes a side surface 3316 enclosing the slot 3315. The side surface 3316 defines at least one notch 3317. In at least one embodiment, the side surface 3316 defines one notch 3317.

Referring to FIG. 13(c), processing surface treatment to the frame 331 to cooperatively form a non-conductive film 3318 by the side surface 3316 and the surface forming the notch 3317. The non-conductive film 3318 is received in the slot 3315 and has width of 5 micron to 1 millimeter. Preferably, the width of the non-conductive film 3318 is 10 micron to 500 micron. The non-conductive film 3318 is made of non-conductive material, can be such as aluminum oxide, titanium, magnesium oxide, zinc oxide, zirconium oxide, columbium oxide, and iron oxide.

The non-conductive film 3318 can also be formed on the middle board 3312 to improve a conjunction of the non-conductive film 3318 and the frame 331. The surface treatment can be chemical treatment, anodic oxidation treatment, microarc oxidation treatment, vacuum coating treatment, or spraying treatment.

Referring to FIG. 13D, forming the antenna 37 in the slot 3315. The non-conductive film 3318 covers the antenna 37 to insulate the antenna 37 from the frame 331. The antenna 37 can be made by printing or filling metal magma, such as copper or silver. A part of the material is inserted into the notch 3317 to form the inlay 371 when forming the antenna 37.

Referring to FIG. 13E, thinning the frame 331. Concretely, thinning the first surface 3313 and the second surface 3314 by metal cutting or polishing to make the slot 3315 throughout the first surface 3313 and the second surface 3314. Removing the antenna material that overflow from the slot 3315 to flat the first surface 3313 and the second surface 3314. Processing surface treatment to the first surface 3313, such as anodic oxidation treatment or polishing, to improve a better appearance effect.

The slot 3315 and the non-conductive film 3318 are corresponding to the antenna 37, the antenna signal may be transmitted via the non-conductive film 3318 to improve radiation efficiency of the electronic device 300.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. A housing used in an electronic device having an antenna, the housing comprising:
a base defining a slot corresponding to the antenna, the base forming a surface enclosing the slot; and
a non-conductive film formed on a surface of the base, the non-conductive film configured to be coupled to the antenna and insulated the antenna from the base.

2. The housing as claimed in claim 1, wherein the slot is configured to receive the antenna.

3. The housing as claimed in claim 2, wherein the surface of the base enclosing the slot defines at least one groove, the non-conductive film forms on a surface of the groove.

4. The housing as claimed in claim 3, wherein the antenna includes at least one inlay correspondingly coupled to the at least one groove, the non-conductive film is sandwiched between the antenna and the surface enclosing the groove.

5. The housing as claimed in claim 1, wherein the housing is a frame, the slot is defined throughout the frame, the non-conductive film is filled in the slot to be coupled to and insulated from the frame.

6. The housing as claimed in claim 5, wherein a surface of the frame enclosing the slot defines at least one notch, the antenna includes at least one inlay correspondingly coupled to the at least one notch, the antenna is firmly coupled to and insulated from the frame by the non-conductive film.

7. The housing as claimed in claim 1, wherein a thickness of the non-conductive film is 5 micron to 5 millimeter.

8. An electronic device comprising:
an antenna; and
a housing comprising:
a base defining a slot corresponding to the antenna, the base forming a surface enclosing the slot; and
a non-conductive film formed on a surface of the base, the non-conductive film configured to be coupled to the antenna and insulated the antenna from the base.

9. The electronic device as claimed in claim 8, wherein the slot is configured to receive the antenna.

10. The electronic device as claimed in claim 9, wherein the surface of the base enclosing the slot defines at least one groove, the non-conductive film forms on a surface of the groove.

11. The electronic device as claimed in claim 10, wherein the antenna includes at least one inlay correspondingly coupled to the at least one groove, the non-conductive film is sandwiched between the antenna and the surface enclosing the groove.

12. The electronic device as claimed in claim 8, wherein the housing is a frame, the slot is defined throughout the frame, the non-conductive film is filled in the slot to be coupled to and insulated from the frame.

13. The electronic device as claimed in claim 12, wherein a surface of the frame enclosing the slot defines at least one notch, the antenna includes at least one inlay correspondingly coupled to the at least one notch, the antenna is firmly coupled to and insulated from the frame by the non-conductive film.

14. The electronic device as claimed in claim 8, wherein a thickness of the non-conductive film is 5 micron to 5 millimeter.

15. A manufacturing method of a housing, the manufacturing method comprising providing a base;
cutting the base to form a slot recessed into the base;
processing surface treatment to the base to form a non-conductive film on a surface of the slot; and
thinning the base to form the slot throughout the base.

16. The manufacturing method as claimed in claim 15, further comprising filling metal material into the slot with the non-conductive film to form an antenna;
wherein the antenna and the base are connected and insulated by the non-conductive film.

17. The manufacturing method as claimed in claim 16, further comprising:
forming at least one groove recessed from surface of the slot, a surface of the groove covered by the non-conductive film; and
forming at least one inlay on the antenna by part of the metal material filled into the slot.

18. The manufacturing method as claimed in claim 16, further comprising:
filling non-conductive material into the slot to form the non-conductive film.

19. The manufacturing method as claimed in claim 15, further comprising:
processing surface treatment to the base, including anodic oxidation treatment or polishing, to improve a better appearance effect of the first surface.

20. The manufacturing method as claimed in claim 15, wherein the surface treatment is chemical treatment, anodic oxidation treatment, microarc oxidation treatment, vacuum coating treatment, or spraying treatment.
